(19) United States
(12) Patent Application Publication
(10) Pub. No.: US 2009/0008430 A1
(43) Pub. Date: Jan. 8, 2009

(54) Solder-bonding process

(75) Inventors: Nagesh R. Basavanhally, Skillman, NJ (US); Raymond A. Cirelli, Hillsborough, NJ (US); Avinoam Kornblit, Highland Park, NJ (US)

Correspondence Address: Jay M. Brown, 6409 Fayetteville Road, Suite 120-306, Durham, NC, 27713, US

(73) Assignee: Lucent Technologies Inc., Murray Hill, NJ (US)

(21) Appl. No.: 11/825,490

(22) Filed: Jul. 6, 2007

(51) Int. Cl. B23K 1/20

(52) U.S. Cl. 228/177; 427/419.1

(57) ABSTRACT

Methods include providing substrate having substrate surface, forming metal-containing pad on substrate surface, and forming metal-containing protective shell enclosing metal-containing body on metal-containing pad. Methods may include forming sacrificial layer on metal-containing pad and including top surface and cavity, cavity having side wall extending between metal-containing pad and top surface; and forming metal-containing protective shell in cavity. Methods may also include providing first, second, third and fourth metal-containing pads on first, second, third and fourth substrate surfaces; forming first metal-containing protective shell on first or second metal-containing pad; forming second metal-containing protective shell on third or fourth metal-containing pad; heating first metal-containing protective shell to form solder-bond between first and second substrate surfaces; and heating second metal-containing protective shell to form solder-bond between third and fourth substrate surfaces.

### BACKGROUND OF THE INVENTION

1. Field of the Invention

This invention generally relates to processes of forming solder-bonds between substrates.

2. Related Art

Various types of solder-bonding processes for bonding together substrates have been developed. A solder-bond is typically formed between two substrates by placing a “bump” of a solder composition between the substrates and heating the solder composition bump to a sufficiently elevated temperature to cause the solder composition to form a bond between the substrates. One common problem with solder-bonding processes results from heating the solder composition, as the heat may be transferred to and damage the substrates, or parts of a device or system integrated with the substrates. Another common problem with solder-bonding processes is the formation, on the surface of the solder composition during solder-bonding, of oxides of the elemental metals that are included in the solder composition. Metal oxides often impede formation of a bond between the solder composition and a substrate, leading to poor mechanical properties of the bond and potentially its failure. Where a solder-bond is formed between two conductive substrates, metal oxides may impede formation of a conductive pathway through the solder-bond between the substrates. Fluxes have been included in solder compositions to eliminate metal oxides, but such fluxes contaminate the solder-bond environment, pollute the atmosphere, and have the potential to impede operation of opto-electronic and Micro-Electro-Mechanical Systems (“MEMS”) formed on or near the substrates.

Accordingly, there is a continuing need for new techniques for forming solder-bonds between substrates that may mitigate common problems with solder-bonding processes, including heat-induced damage to devices and systems to be bonded together, and metal oxide—induced poor substrate bonding.

### SUMMARY

In an example of an implementation, a method is provided that includes providing a substrate having a substrate surface, and forming a metal-containing pad on the substrate surface. The method further includes forming a solder composition including a metal-containing protective shell on the metal-containing pad, at least a part of the metal-containing protective shell having a first composition, the metal-containing protective shell enclosing a metal-containing body having a second composition.

In another implementation, for example, a method is provided that includes providing a substrate having a substrate surface, and forming a metal-containing pad on the substrate surface. The method further includes forming a sacrificial layer on the metal-containing pad, the sacrificial layer including a top surface and a cavity having a side wall, the side wall extending between the metal-containing pad and the top surface, the side wall having a first perimeter at the top surface and a second perimeter proximate to the metal-containing pad and a third perimeter at an intermediate point between the top surface and the metal-containing pad, the third perimeter being larger than the first and second perimeters. A first part of a metal-containing protective shell is formed in the cavity, the first part of the metal-containing protective shell having an opening proximate to the intermediate point, the first part of the metal-containing protective shell having a first composition. The method also includes forming in the first part of the metal-containing protective shell, a metal-containing body having a second composition. A second part of the metal-containing protective shell is formed at the opening, the first and second parts of the metal-containing protective shell enclosing the metal-containing body.

As an example of a further implementation, a method is provided that includes providing a first substrate having a first substrate surface, a second substrate having second and third substrate surfaces, and a third substrate having a fourth substrate surface. First, second, third and fourth metal-containing pads respectively are formed on the first, second, third and fourth substrate surfaces. The method includes forming a first metal-containing protective shell on the first or second metal-containing pad, at least a part of the first metal-containing protective shell having a first composition, the first metal-containing protective shell enclosing a metal-containing body having a second composition. The first and second substrate surfaces are juxtaposed with the first metal-containing protective shell aligned between and contacting the first and second metal-containing pads, and the first metal-containing protective shell is heated to a first temperature to form a solder-bond between the first and second substrate surfaces. The method also includes forming a second metal-containing protective shell on the third or fourth metal-containing pad, at least a part of the second metal-containing protective shell having a third composition, the second metal-containing protective shell enclosing a metal-containing body having a fourth composition. The third and fourth substrate surfaces are juxtaposed with the second metal-containing protective shell aligned between and contacting the third and fourth metal-containing pads, and the second metal-containing protective shell is heated to a second temperature to form a solder-bond between the third and fourth substrate surfaces.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a flow chart showing an example of an implementation of a method.

FIG. 2 is a perspective view showing an example of a metal-containing protective shell enclosing a metal-containing body, on a metal-containing pad on a substrate surface, formed according to the method shown in FIG. 1.

FIG. 3 is a top view taken along the direction of line A of FIG. 2, showing the metal-containing protective shell enclosing the metal-containing body on the metal-containing pad on the substrate surface.

FIG. 4 is a flow chart showing an example of an implementation of another method.

FIG. 5 is a cross-sectional side view showing an example of a sacrificial layer formed on a metal-containing pad and having a cavity in which a metal-containing protective shell enclosing a metal-containing body may be formed, in carrying out the method shown in FIG. 4.

FIG. 6 is a top view, taken along the direction of the arrow B, of the sacrificial layer, metal-containing pad, cavity and substrate shown in FIG. 5.

FIG. 7 is a cross-sectional side view showing the sacrificial layer formed on the metal-containing pad and having the cavity shown in FIGS. 5-6, in which a first part of a metal-containing protective shell has been formed, in carrying out the method shown in FIG. 4.

FIG. 8 is a cross-sectional side view of the first part of the metal-containing protective shell shown in FIG. 7, in which a metal-containing body has been formed in carrying out the method shown in FIG. 4.

FIG. 9 is a cross-sectional side view showing the sacrificial layer formed on the metal-containing pad and having the cavity shown in FIG. 8, in which the first and second parts of a completed metal-containing protective shell enclosing a metal-containing body have been formed, in carrying out the method shown in FIG. 4.

FIG. 10 is a cross-sectional side view showing another example of a sacrificial layer formed on a metal-containing pad in which first and second parts of a completed metal-containing protective shell enclosing a metal-containing body have been formed in carrying out an example of the method shown in FIG. 4.

FIG. 11 is a cross-sectional side view showing another example of a sacrificial layer including first, second and third sacrificial sub-layers, successively formed on the metal-containing pad in carrying out another example of the method shown in FIG. 4.

FIG. 12 is a cross-sectional side view showing the sacrificial layer formed as shown in FIG. 11 on the metal-containing pad, having a cavity formed in carrying out this example of the method shown in FIG. 4.

FIG. 13 is a cross-sectional side view showing the sacrificial layer formed on the metal-containing pad and having the cavity shown in FIG. 12, in which a first part of a metal-containing protective shell has been formed, in carrying out this example of the method shown in FIG. 4.

FIG. 14 is a cross-sectional side view of the first part of a metal-containing protective shell shown in FIG. 13, in which a metal-containing body has been formed in carrying out this example of the method shown in FIG. 4.

FIG. 15 is a cross-sectional side view of the sacrificial layer on the metal-containing pad and having the cavity shown in FIG. 12, in which first and second parts of a completed metal-containing protective shell enclosing a metal-containing body have been formed in carrying out this example of the method shown in FIG. 4.

FIG. 16 is a flow chart showing an example of an implementation of an additional method.

### DETAILED DESCRIPTION

Methods are provided that include providing a substrate having a substrate surface. A metal-containing pad is formed on the substrate surface. A metal-containing protective shell is formed on the metal-containing pad, the metal-containing protective shell enclosing a metal-containing body. The metal-containing protective shell and metal-containing body are suitable for subsequent heating to form a solder-bond between the substrate and another substrate. A method may, for example, include forming a sacrificial layer on a metal-containing pad, the sacrificial layer including a top surface and a cavity, the cavity having a side wall extending between the metal-containing pad and the top surface. A metal-containing protective shell may then be formed in the cavity. A method may, in another example, include providing a first substrate having a first substrate surface, a second substrate having second and third substrate surfaces, and a third substrate having a fourth substrate surface. Metal-containing pads may be formed, for example, on the first, second, third and fourth substrate surfaces. A first metal-containing protective shell may be formed on the first or second metal-containing pad, and a second metal-containing protective shell may be formed on the third or fourth metal-containing pad. The first metal-containing protective shell may be heated, in an example, to form a solder-bond between the first and second substrate surfaces. The second metal-containing protective shell may be heated, for example, to form a solder-bond between the third and fourth substrate surfaces.

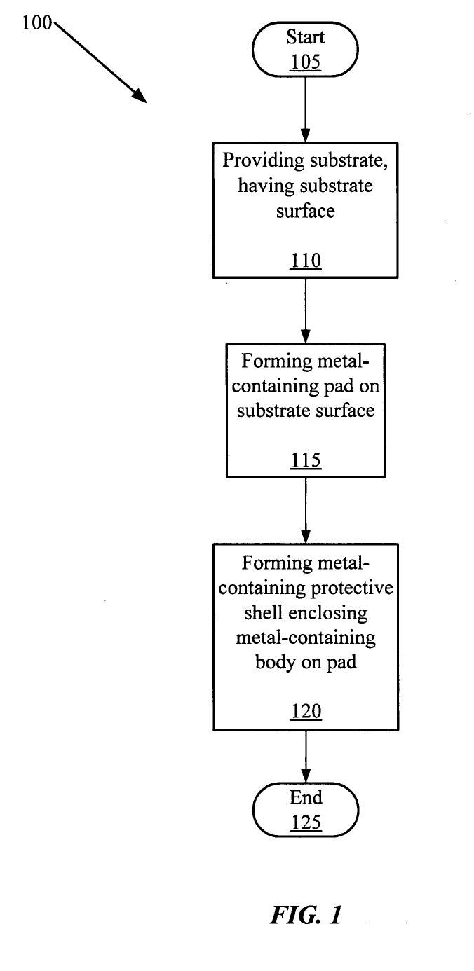

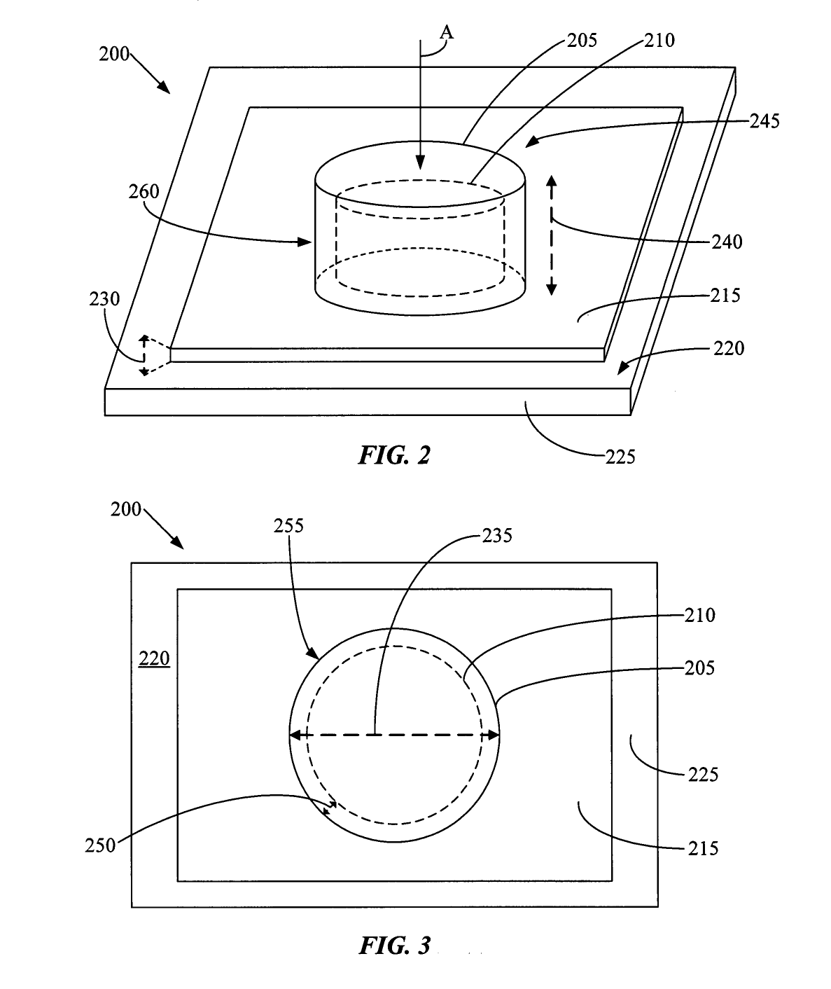

FIG. 1 is a flow chart showing an example of an implementation of a method 100. According to the method 100, a metal-containing protective shell enclosing a metal-containing body is formed on a metal-containing pad on a substrate surface. FIG. 2 is a perspective view showing an example 200 of such a metal-containing protective shell 205 enclosing a metal-containing body 210, on a metal-containing pad 215 on a substrate surface 220, formed according to the method 100. The method starts at step 105, and then at step 110 a substrate 225 is provided, having the substrate surface 220. Providing the substrate 225 at step 110 may include, as examples, selecting a pre-formed substrate 225, or forming the substrate 225 from a larger pre-formed solid body (not shown), or forming the substrate 225 by a deposition process such by as spin coating of a flowable composition or by vapor deposition of a composition in a form such as atoms, ions, molecules or particles, as examples. The substrate 225 may have a composition selected, for example, for its performance properties such as mechanical strength, dimensional stability, and electrical conducting, semi-conducting, or insulating properties. As examples, the substrate 225 may be formed of a composition selected from silicon, crystalline silicon, silicon dioxide, silicon carbide, silicon nitride, an elemental metal or alloy, or a Group III/V semiconductor composition. In another example, the substrate 225 may be formed of a non-conductive composition such as silicon dioxide, and may include a via filled with a conductive composition communicating with the substrate surface 220. Further, for example, a solder-bond may be formed between the substrate 225 and another substrate, so that the solder-bond is in electrical communication with the filled via.

At step 115, the metal-containing pad 215 is formed on the substrate surface 220. For example, the metal-containing pad 215 may have a composition selected as having bonding compatibility with the substrate surface 220 and with the metal-containing protective shell 205 to be formed on the metal-containing pad 215. In another example, the metal-containing pad 215 may include a first pad layer (not shown) forming a strong bond with the substrate surface 220. As a further example, the metal-containing pad 215 may include a second pad layer (not shown) on the first pad layer, the second pad layer serving as a barrier against air oxidation of and forming a strong bond with the first pad layer, and forming a strong bond with the metal-containing protective shell 205. As an additional example, the metal-containing pad 215 may include a third pad layer (not shown) between the first and second pad layers, the third pad layer providing a barrier to migration of ions or atoms diffusing out from the first or second pad layers. The first pad layer may include, as examples, titanium, chromium, or both. The second pad layer may include, as examples, gold, silver, or both. The third pad layer may include, as examples, platinum, palladium, vanadium, tungsten, nickel, or an alloy of two or more of such elemental metals. In examples, the first, second and third pad layers may have thicknesses in the directions of the arrow 230, respectively within ranges of: between about 500 Angstroms and about 1000 Angstroms, between about 100 Angstroms and about 500 Angstroms, and between about 1000 Angstroms and about 3000 Angstroms. As another example, the third pad layer may have a thickness in the directions of the arrow 230 of at least 2000 Angstroms.

In step 120, the metal-containing protective shell 205 is formed on the metal-containing pad 215, the metal-containing protective shell 205 enclosing the metal-containing body 210. The method 100 may end at step 125.

FIG. 3 is a top view taken along the direction of line A of FIG. 2, showing the metal-containing protective shell 205 enclosing the metal-containing body 210 on the metal-containing pad 215 on the substrate surface 220. The metal-containing protective shell 205 may, for example, have a generally cylindrical shape including a diameter 235, a height 240, and a volume 245. In an example, the metal-containing protective shell 205 may have a volume 245 selected as suitable for heating the metal-containing protective shell 205 and the metal-containing body 210 to form a solder-bond between the metal-containing pad 215 on the substrate 225, and a metal containing pad (not shown) on another substrate. For example, the metal-containing protective shell 205 and the metal-containing body 210 may together form a solder composition suitable for heating to form a solder-bond.

As an example, the diameter 235 of the metal-containing protective shell 205 may be within a range of between about 5 microns and about 200 microns. In another example, the height 240 of the metal-containing protective shell 205 may be within a range of between about 5 microns and about 150 microns. In a further example, the volume 245 defined by the metal-containing protective shell 205 may be within a range of between about 100 cubic microns and about 19 million cubic microns. As another example, the diameter 235 of the metal-containing protective shell 205 may be within a range of between about 5 microns and about 25 microns. In another example, the height 240 of the metal-containing protective shell 205 may be within a range of between about 5 microns and about 25 microns, or within a range of between about 5 microns and about 8 microns. In a further example, the volume 245 defined by the metal-containing protective shell 205 may be within a range of between about 100 cubic microns and about 2,500 cubic microns.

The metal-containing protective shell 205 may have an average thickness 250, enclosing the metal-containing body 210, sufficiently large to minimize or eliminate pinholes or other defects that would result in exposure of a part of the metal-containing body 210 to an ambient environment. For example, the metal-containing protective shell 205 may have an average thickness 250 of at least 100 Angstroms, enclosing the metal-containing body 210. The metal-containing protective shell 205 may, for example, have a shape that is generally cylindrical, but including a perimeter 255 that is (not shown) elliptical or otherwise distorted from the circular perimeter 255 shown in FIG. 3. As further examples (not shown) the perimeter 255 shown in FIG. 3 may be substituted by a perimeter that is square, rectangular, triangular, star-shaped, elliptical, pentagonal, or that has another polygonal, regular, or irregular shape. In another example, the perimeter 255 shown in FIG. 3 may be substituted by a perimeter (not shown) including an elongated rectangle having two short sides and two long sides. For example, the short sides may have lengths within a range of between about 5 microns and about 200 microns; and the long sides may have any length. As another example, the short sides may have lengths within a range of between about 5 microns and about 20 microns; and the long sides may have any length. The metal-containing protective shell 205 has a lateral wall 260 shown in FIG. 2 as having a generally regular surface forming a cylinder. As another example (not shown), the lateral wall 260 may be tapered or otherwise irregular.

At least a part of the metal-containing protective shell 205 has a first composition; and the metal-containing body 210 has a second composition. Where a first part and a second part of the metal-containing protective shell 205 are separately formed, for example, the first and second parts may have substantially the same first composition, or different first compositions. In another example, the second composition may be susceptible to some form of degradation or other change that may be induced in a body (not shown) of the second composition by an external ambient environment, such as an ambient environment where the metal-containing body 210 is to be located during end-utilization in forming a solder-bond. As another example, the first composition of the metal-containing protective shell 205 may be selected as suitable to protect the metal-containing body 210 from such degradation or other change during such end-utilization.

Solder-bonds may be formed, for example, by heating two or more elemental metals together. The heating may cause one or more of the elemental metals to flow or diffuse into another of the elemental metals. As an example, one of such elemental metals may be subject to oxidation on contact with ambient oxygen, or may be subject to some other chemical reaction on contact with air or with another ambient environment. In examples, the metal-containing body 210 may be formed of a second composition that is susceptible to air oxidation. For example, elemental indium, tin, copper, bismuth, zinc and lead are subject to oxidation upon contact with oxygen. The metal-containing protective shell 205 may be formed of a first composition that is resistant to, as examples, oxidation on contact with ambient oxygen, or resistant to some other chemical reaction, on contact with air or with another ambient environment. In an example, the first composition may be resistant to air oxidation. For example, the metal-containing protective shell 205 may be formed of a first composition including one or more elemental metals selected from gold, palladium, platinum, and silver. The metal-containing body 210 may accordingly be formed of a second composition including one or more metals selected from indium, tin, copper, bismuth, zinc and lead.

Heating the metal-containing protective shell 205 and the metal-containing body 210 in forming a solder-bond generally results in sublimation or evaporation of any non-metallic additives, such as elements and compounds that may be included in the first or second compositions. However, it is understood that such non-metallic additives as may generally be utilized together with elemental metals in forming a solder-bond, may be included in either of the first and second compositions.

As a further example, the first and second compositions may be selected so that a high-melting inter-metallic alloy is formed upon heating of the metal-containing protective shell 205 and the metal-containing body 210. For example, the metal-containing body 210 may be formed of a second composition that includes a low-melting elemental metal capable of forming an inter-metallic alloy with one or more elemental metals selected from gold, palladium, platinum, and silver, the inter-metallic alloy having a melting point higher than a melting point of the low-melting elemental metal. The metal-containing protective shell 205 may accordingly be formed of a first composition that includes one or more elemental metals suitable for inclusion in the inter-metallic alloy, such elements selected from gold, palladium, platinum, and silver. As examples, the first and second compositions may form an inter-metallic alloy selected from gold-indium, silver-indium, and gold-tin. For example, a gold-indium inter-metallic alloy including indium at a concentration within a range of between about 60 percent (%) and about 70% (by weight), and including gold at a concentration within a range of between about 40% and about 30% by weight.

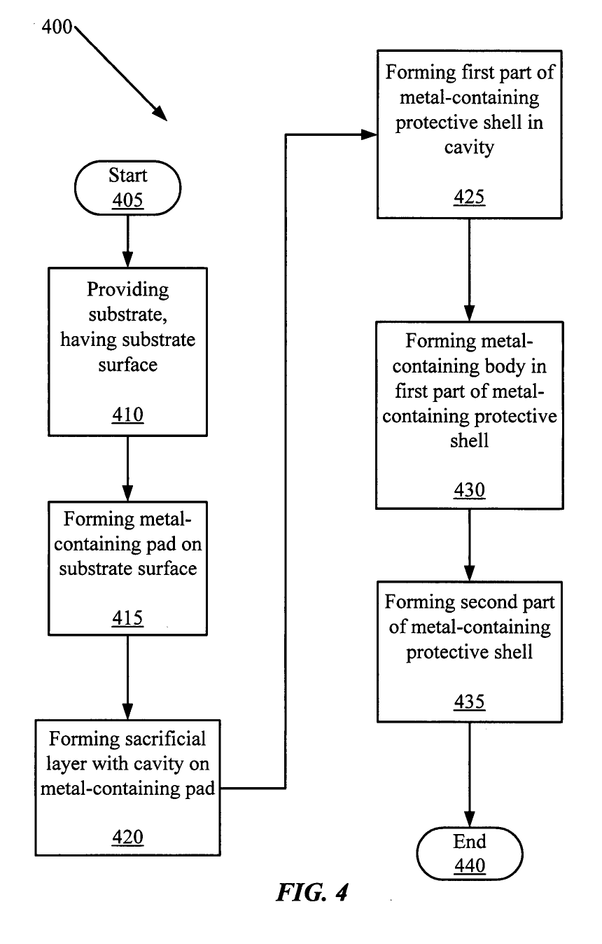

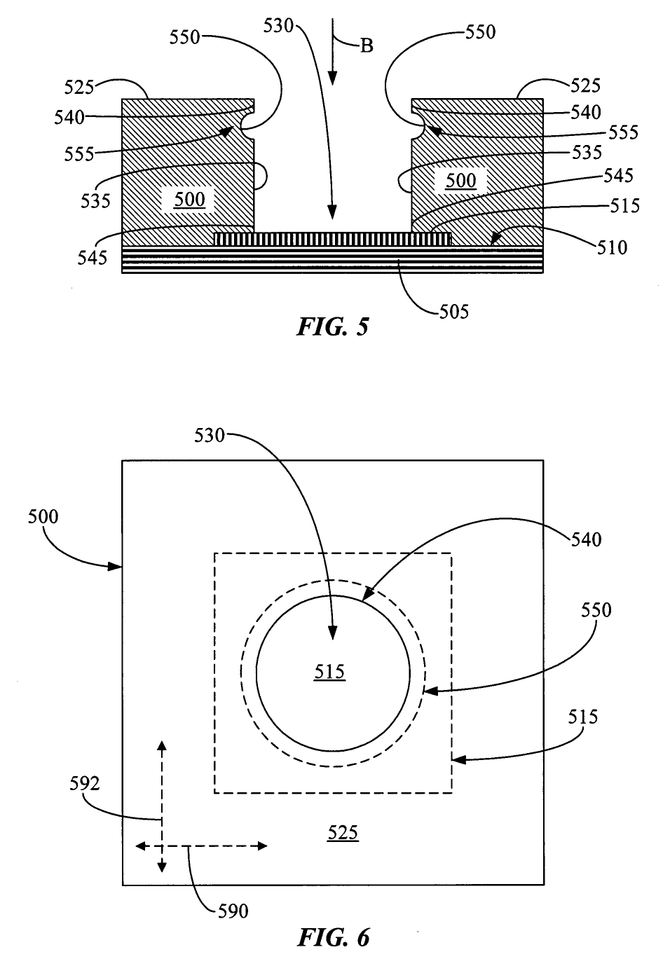

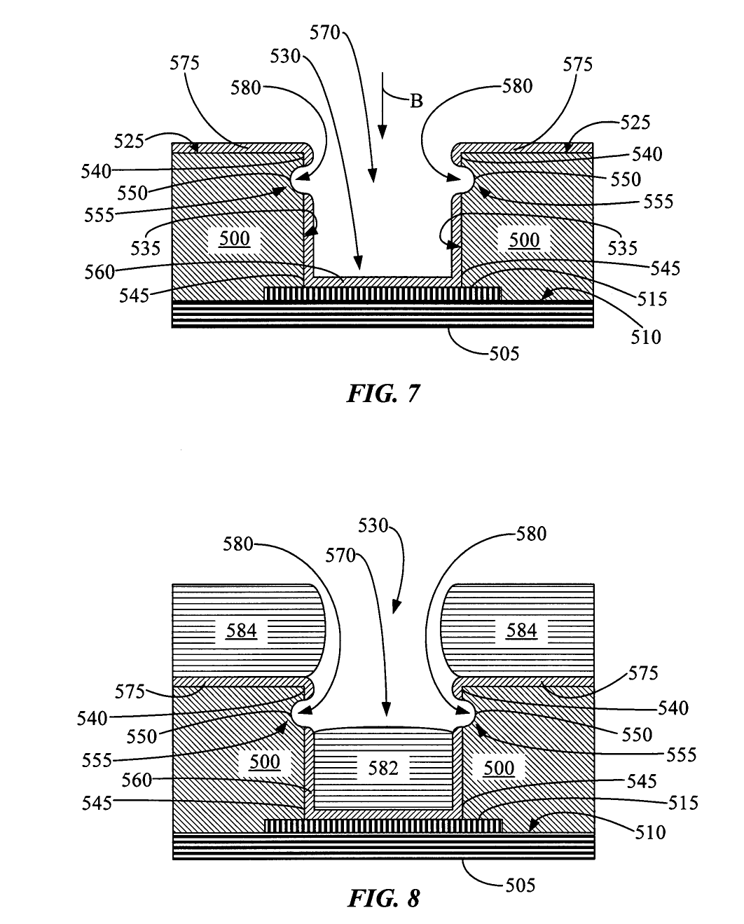

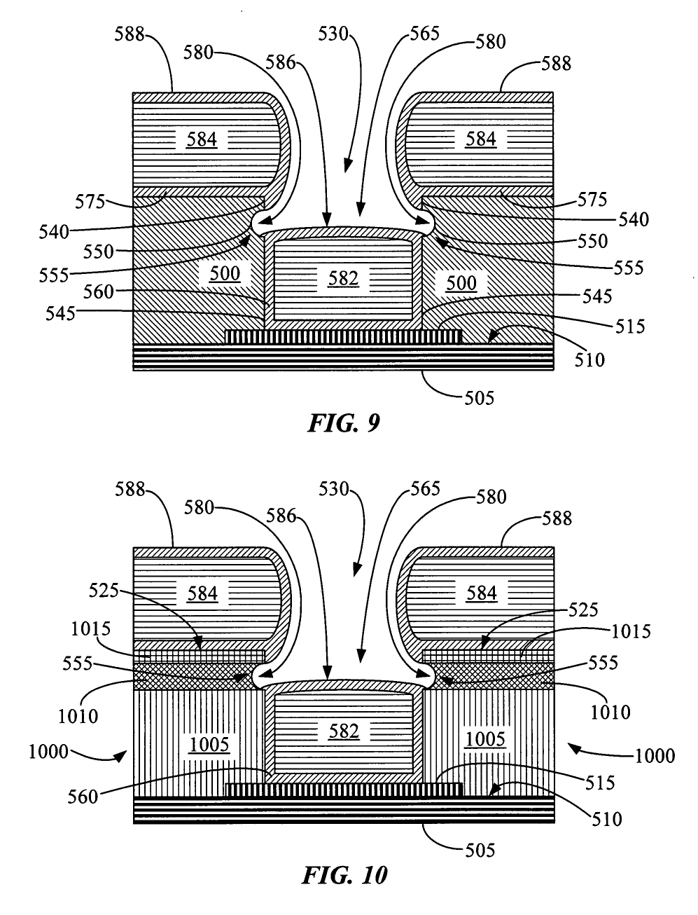

FIG. 4 is a flow chart showing an example of an implementation of another method 400. According to the method 400, a metal-containing protective shell enclosing a metal-containing body is formed on a metal-containing pad on a substrate surface. The entirety of the above discussion of the method 100 in connection with FIGS. 1-3 is fully applicable in carrying out the method 400, and hereby is incorporated in this discussion of the method 400. FIG. 5 is a cross-sectional side view showing an example of a sacrificial layer formed on a metal-containing pad and having a cavity in which a metal-containing protective shell enclosing a metal-containing body may be formed, in carrying out the method 400. FIG. 6 is a top view, taken along the direction of the arrow B, of the sacrificial layer, metal-containing pad, cavity and substrate shown in FIG. 5. FIG. 7 is a cross-sectional side view showing the sacrificial layer formed on the metal-containing pad and having the cavity shown in FIGS. 5-6, in which a first part of a metal-containing protective shell has been formed, in carrying out the method 400. FIG. 8 is a cross-sectional side view of the first part of the metal-containing protective shell shown in FIG. 7, in which a metal-containing body has been formed in carrying out the method 400. FIG. 9 is a cross-sectional side view showing the sacrificial layer formed on the metal-containing pad and having the cavity shown in FIG. 8, in which the first and second parts of a completed metal-containing protective shell enclosing a metal-containing body have been formed, in carrying out the method 400.

The method 400 starts at step 405, and then at step 410 a substrate 505 is provided, having a substrate surface 510. Providing the substrate 505 at step 410 may include, as examples, selecting a pre-formed substrate 505, or forming the substrate 505 from a larger pre-formed solid body (not shown), or forming the substrate 505 by a deposition process such as spin coating of a flowable composition or by vapor deposition of a composition in a form such as atoms, ions, molecules or particles, as examples. The substrate 505 may have a composition selected, for example, in the same manner as discussed above in connection with step 110 of the method 100.

At step 415, a metal-containing pad 515 is formed on the substrate surface 510. For example, the metal-containing pad 515 may have a composition selected as having bonding compatibility with the substrate surface 510 and with a metal-containing protective shell to be formed on the metal-containing pad 515. In further examples, the metal-containing pad 515 may include one or more pad layers selected from first, second, and third pad layers (not shown), in the same manner as discussed above in connection with step 115 of the method 100.

At step 420 a sacrificial layer 500 is formed on the metal-containing pad 515, the sacrificial layer 500 including a top surface 525 and a cavity 530 having a side wall 535, the side wall 535 extending between the metal-containing pad 515 and the top surface 525. In an example, the sacrificial layer 500 may also be on at least a part of the substrate surface 510, as shown in FIG. 5. The side wall 535 has a first perimeter 540 at the top surface 525, a second perimeter 545 proximate to the metal-containing pad 515, and a third perimeter 550 at an intermediate point 555 between the top surface 525 and the metal-containing pad 515, the third perimeter 550 being larger than the first and second perimeters 540, 545. As an example, the first perimeter 540 and the second perimeter 545 may be substantially the same. The sacrificial layer 500 is formed of a composition selected as suitable for subsequent removal from the metal-containing pad 515 and from the substrate surface 510. For example, the sacrificial layer 500 may have a composition selected from a photo-resist, an organic polymer, or a metal oxide, metal carbide or metal nitride. As examples, silicon dioxide, silicon carbide, and silicon nitride may be utilized. The sacrificial layer 500 may be formed on the metal-containing pad 515, and in some examples also formed on at least a part of the substrate surface 510, by deposition of a liquid coating, a vapor, or a plasma as examples. The cavity 530 may be formed, for example, by isotropic and anisotropic dry or wet etching techniques carried out on the sacrificial layer 500. As an example, isotropic etching may be carried out utilizing an oxygen plasma at a pressure of greater than 10 m Torr (1 Torr=1,000 m Torr). In another example, anisotropic etching may be carried out utilizing an oxygen plasma at about 5 m Torr or less; or utilizing a carbon dioxide plasma.

At step 425, a first part 560 of a metal-containing protective shell 565 is formed in the cavity 530, the first part 560 of the metal-containing protective shell 565 having an opening 570 proximate to the intermediate point 555. The first part 560 of the metal-containing protective shell 565 is formed of a first composition. The first composition may be selected in the same manner as discussed above in connection with selecting the first composition of the metal-containing protective shell 205 formed in step 120 of the method 100. The first part 560 of the metal-containing protective shell 565 is formed in the cavity 530 by utilizing a selected technique for depositing the first composition onto the top surface 525 of the sacrificial layer 500, onto the metal-containing pad 515, and onto the side wall 535. As examples, the selected depositing technique may include evaporation, sputtering, or electroplating. The selected depositing technique is carried out in a manner such that first part 560 of the metal-containing protective shell 565 is formed simultaneously with deposition of a layer 575 of the first composition onto the top surface 525, separated by a discontinuity 580 at the intermediate point 555. The first perimeter 540 at the top surface 525, being smaller than the third perimeter 550 at the intermediate point 555, may prevent deposition of the coating of the first composition to completely cover the intermediate point 555, generating the discontinuity 580. The second perimeter 545 proximate to the metal-containing pad 515, being smaller than the third perimeter 550, may have a size and shape selected so that the first perimeter 540 allows the side wall 535 below the intermediate point 555 to be coated by the first composition. For example, the first and second perimeters 540, 545 may have substantially the same size and shape. The discontinuity 580 may facilitate later separation of the sacrificial layer 500 and the layer 575 from the metal-containing protective shell 565.

At step 430, a metal-containing body 582 is formed in the first part 560 of the metal-containing protective shell 565. The metal-containing body 582 is formed of a second composition. The second composition may be selected in the same manner as discussed above in connection with selecting the second composition of the metal-containing body 210 formed in step 120 of the method 100. The metal-containing body 582 is formed in the cavity 530 by utilizing a selected technique for depositing the second composition as a layer 584 onto the layer 575 of the first composition, and into the first part 560 of the metal-containing protective shell 565. As examples, the selected depositing technique may include evaporation, sputtering, or electroplating.

At step 435, a second part 586 of the metal-containing protective shell 565 is formed on the opening 570, enclosing the metal-containing body 582 together with the first part 560 of the metal-containing protective shell 565. The second part 586 of the metal-containing protective shell 565 is formed of a selected metal-containing composition. The metal-containing composition of the second part 586 of the metal-containing protective shell 565 may be selected in the same manner as discussed above in connection with selecting the first composition of the metal-containing protective shell 205 formed in step 120 of the method 100. As an example, the first and second parts 560, 586 of the metal-containing protective shell 565 may have substantially the same composition. The second part 586 of the metal-containing protective shell 565 is formed utilizing a selected technique for depositing the selected metal-containing composition onto the layer 584 and onto the metal-containing body 582, closing the opening 570. As examples, the selected depositing technique may include evaporation, sputtering, or electroplating. The selected depositing technique is carried out in a manner such that the second part 586 of the metal-containing protective shell 565 is formed simultaneously with deposition of a layer 588 of the metal-containing composition onto the layer 584 of the second composition, separated by the discontinuity 580 at the intermediate point 555. The method 400 may then end at step 440.

In another example, the discontinuity 580 may then facilitate separation of the sacrificial layer 500 and the layers 575, 584 and 588 from the metal-containing protective shell 565. For example, a solvent suitable to dissolve the sacrificial layer 500 may be applied onto the layer 588. The discontinuity 580 then may provide a pathway for the solvent to reach and dissolve the sacrificial layer 500, carrying away the layers 575, 584 and 588 as well.

FIG. 10 is a cross-sectional side view showing another example 1000 of a sacrificial layer formed on the metal-containing pad 515 and having the cavity 530 in which the first and second parts 560, 586 of the completed metal-containing protective shell 565 enclosing the metal-containing body 582 have been formed in carrying out an example of the method 400. Forming the sacrificial layer 1000 at step 420 in the method 400 may include successively forming a first sacrificial sub-layer 1005, a second sacrificial sub-layer 1010, and a third sacrificial sub-layer 1015 on the metal-containing pad 515. In an example, the first sacrificial sub-layer 1005 may be thicker on the metal-containing pad 515 than the second or third sacrificial sub-layers 1010 and 1015. As another example, the second sacrificial sub-layer 1010 may be thicker on the metal-containing pad 515 than the third sacrificial sub-layer 1015. The third, second and first sacrificial sub-layers 1015, 1010, 1005 may then be selectively removed over lateral regions of the substrate surface 510, such lateral regions being defined by the directions of the arrows 590, 592 in FIG. 6. In this example of the method 400, the second sacrificial sub-layer 1010 is removed over a larger lateral region than the third sacrificial sub-layer 1015, and may also be removed over a larger lateral region than the first sacrificial sub-layer 1005. This selective removal may be facilitated, for example, by forming the first and third sacrificial sub-layers 1005, 1015 of a first sacrificial composition and forming the second sacrificial sub-layer 1010 of a second sacrificial composition selected as being more susceptible to subsequent removal by a solvent than the first and third sacrificial sub-layers 1005, 1015, following patterned exposure of the sacrificial layer 1000 to electromagnetic radiation such as light. For example, the first and second sacrificial compositions may be photo-resists. In examples, the patterned exposure to light may be carried out utilizing soft x-rays or mid- or deep-ultra-violet or visible light.

In an example, the first sacrificial sub-layer 1005 may be formed on the metal-containing pad 515 and then subjected to patterned exposure to light at one or more selected wavelengths, followed by curing at a first temperature for a first time period. The second sacrificial sub-layer 1010 may then be formed on the first sacrificial sub-layer 1005 and subjected to the same light exposure followed by curing at a second temperature lower than the first temperature, for a second time period shorter than the first time period. The third sacrificial sub-layer 1015 may then be formed on the second sacrificial sub-layer 1010 and subjected to the same light exposure and curing as the second sacrificial sub-layer. In an example, the first temperature may be about 130 degrees Celsius (° C.) and the second temperature may be about 115 degrees. The third sacrificial sub-layer 1015 may then be post-treated to increase its resistance to solvent removal, such as by treating the third sacrificial sub-layer 1015 utilizing ion implantation, electron-beam exposure, surface heating by light at one or more wavelengths resulting in curing heat penetration into only the third sacrificial sub-layer 1015, or pulsed photo-magnetic curing. As another example, the third sacrificial sub-layer 1015 may be formed of a composition more resistant to a selected solvent than the second sacrificial composition. Following preparation of the sacrificial layer 1000, the first, second and third sacrificial sub-layers 1005, 1010, 1015 may then be selectively removed to form the cavity 530.

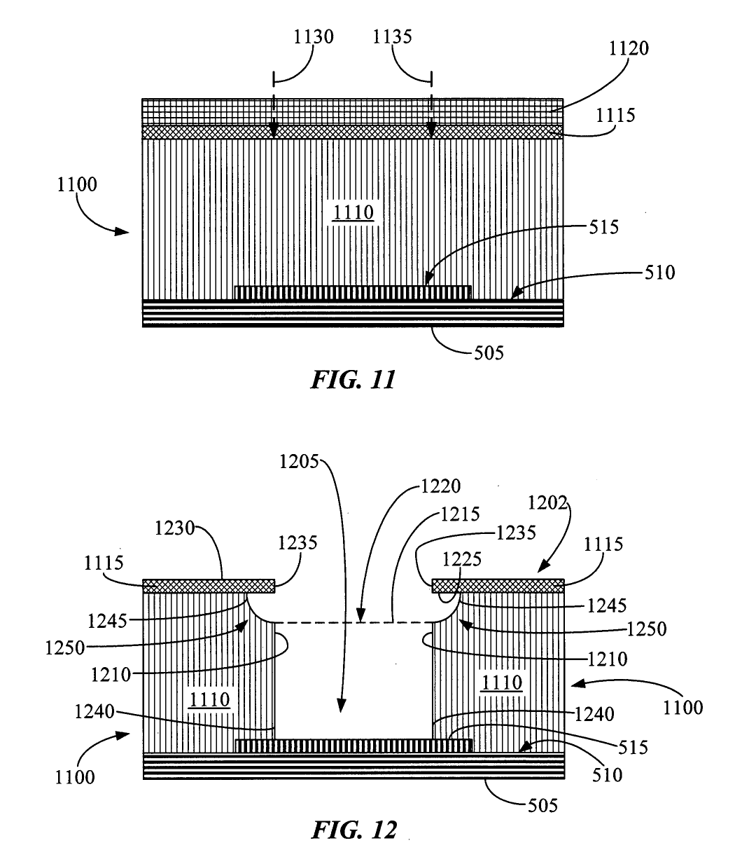

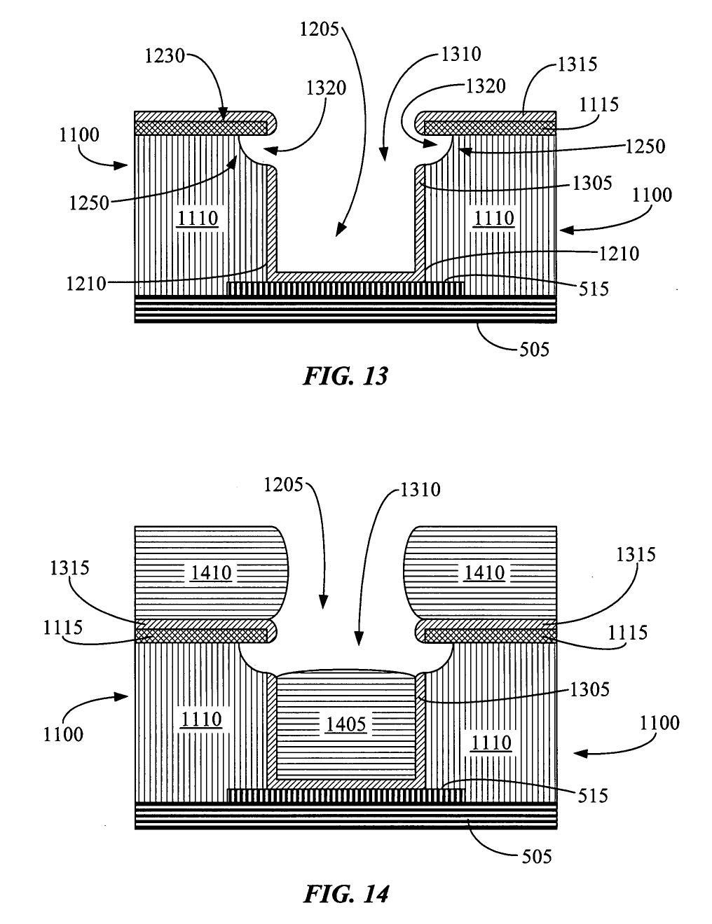

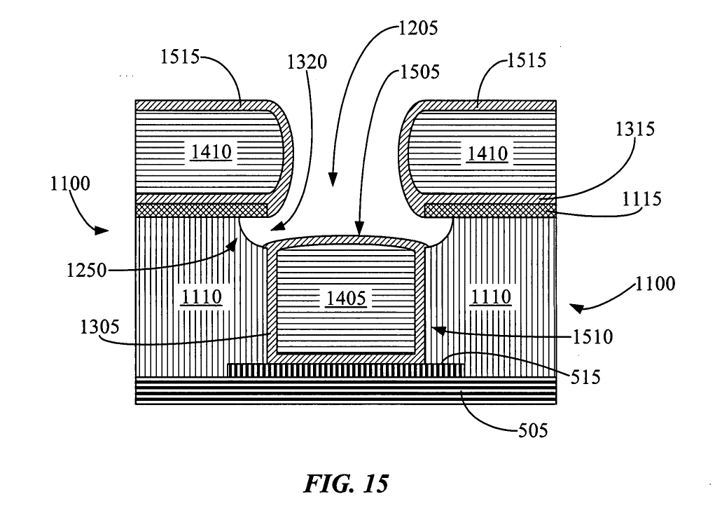

FIG. 11 is a cross-sectional side view showing another example of a sacrificial layer 1100 including first, second and third sacrificial sub-layers 1110, 1115, 1120, successively formed on the metal-containing pad 515 in carrying out another example of the method 400. FIG. 12 is a cross-sectional side view showing the sacrificial layer 1100 formed as shown in FIG. 11 on the metal-containing pad 515, having a cavity 1205 formed in carrying out this example of the method 400. FIG. 13 is a cross-sectional side view showing the sacrificial layer 1100 formed on the metal-containing pad 515 and having the cavity 1205 shown in FIG. 12, in which a first part 1305 of a metal-containing protective shell has been formed, in carrying out this example of the method 400. FIG. 14 is a cross-sectional side view of the first part 1305 of a metal-containing protective shell shown in FIG. 13, in which a metal-containing body 1405 has been formed in carrying out this example of the method 400. FIG. 15 is a cross-sectional side view of the sacrificial layer 1100 on the metal-containing pad 515 and having the cavity 1205 shown in FIG. 12, in which first and second parts 1305, 1505 of a completed metal-containing protective shell 1510 enclosing the metal-containing body 1405 have been formed in carrying out this example of the method 400.

This example of the method 400 starts at step 405, and then at step 410 the substrate 505 is provided, having the substrate surface 510. At step 415, the metal-containing pad 515 is formed on the substrate surface 510.

At step 420, the sacrificial layer 1100 is formed on the metal-containing pad 515, the sacrificial layer 1100 including a top surface and a cavity 1205 having a side wall 1210, the side wall 1210 extending between the metal-containing pad 515 and the sacrificial sub-layer 1115. In an example, the sacrificial layer 1100 may also be on at least a part of the substrate surface 510, as shown in FIGS. 11-12.

Forming the sacrificial layer 1100 at step 420 in this example of the method 400 may include successively forming a first sacrificial sub-layer 1110, a second sacrificial sub-layer 1115, and a third sacrificial sub-layer 1120 on the metal-containing pad 515. The first, second and third sacrificial sub-layers 1110, 1115, 1120 are each formed of compositions selected as suitable for subsequent removal from the metal-containing pad 515 and the substrate surface 510. For example, each of the sacrificial sub-layers 1110, 1115, 1120 may have a composition selected from a photo-resist, an organic polymer, or a metal oxide, metal carbide or metal nitride. As examples, silicon dioxide, silicon carbide, and silicon nitride may be utilized. Each of the sacrificial sub-layers 1110, 1115, 1120 may be formed on the metal-containing pad 515, and in some examples also formed on at least a part of the substrate surface 510, by deposition of a liquid coating, a vapor, or a plasma as examples.

The third and second sacrificial sub-layers 1120 and 1115 may then be selectively removed over a lateral region of the substrate surface 510 in between and defined by the directions of the arrows 1130, 1135. In an example, removal of the lateral region in between and defined by the directions of the arrows 1130, 1135 may generate a perimeter (not shown) having a cylindrical shape. For example, the third sacrificial sub-layer 1120 may be a photo-resist, which is first removed from the region in between and defined by the arrows 1130, 1135. As an example, the third sacrificial sub-layer 1120 may be subjected to patterned soft x-rays or light, and selectively removed by a suitable solvent. In examples, soft x-rays or mid- or deep-ultra-violet or visible light may be utilized. The second sacrificial sub-layer 1115 may then also be removed from the lateral region in between and defined by the arrows 1130, 1135. For example, an etching technique may be utilized. The remainder of the third sacrificial sub-layer 1120 may, as an example, also be removed by an etching process. The first sacrificial sub-layer 1110 may then be removed to a partial depth indicated by the dotted line 1215 towards the metal-containing pad 515 by an isotropic etching technique, forming a cup-shaped cavity 1220. The second sacrificial sub-layer 1115 may be formed of a composition resistant to the isotropic etching technique, leaving an overhang 1225 of the second sacrificial sub-layer 1115 over the cup-shaped cavity 1220. The first sacrificial sub-layer 1110 may then be removed down to the metal-containing pad 515 by an anisotropic etching technique, forming the cavity 1205 having the sidewall 1210. The side wall 1210 has a first perimeter 1235 at the top surface 1230 of the second sacrificial sub-layer 1115, and a second perimeter 1240 proximate to the metal-containing pad 515, and a third perimeter 1245 at an intermediate point 1250 between the top surface 1230 and the metal-containing pad 515, the third perimeter 1245 being larger than the first and second perimeters 1235, 1240. As an example, the first perimeter 1235 and the second perimeter 1240 may be substantially the same.

At step 425, a first part 1305 of a metal-containing protective shell is formed in the cavity 1205, the first part 1305 of the metal-containing protective shell having an opening 1310 proximate to the intermediate point 1250. The first part 1305 of the metal-containing protective shell is formed of a first composition. The first composition may be selected in the same manner as discussed above in connection with selecting the first composition of the metal-containing protective shell 205 formed in step 120 of the method 100. The first part 1305 of the metal-containing protective shell is formed in the cavity 1205 by utilizing a selected technique for depositing the first composition onto the top surface 1230 of the second sacrificial sub-layer 1115, onto the metal-containing pad 515, and onto the side wall 1210. As examples, the selected depositing technique may include evaporation, sputtering, or electroplating. The selected depositing technique is carried out in a manner such that the first part 1305 of the metal-containing protective shell is formed simultaneously with deposition of a layer 1315 of the first composition onto the top surface 1230, separated by a discontinuity 1320 at the intermediate point 1250. The first perimeter 1235 at the top surface 1230, being smaller than the third perimeter 1245 at the intermediate point 1250, may prevent deposition of the coating of the first composition to completely cover the intermediate point 1250, generating the discontinuity 1320. The second perimeter 1240 proximate to the metal-containing pad 515, being smaller than the third perimeter 1245, may have a size and shape selected so that the first perimeter 1235 allows the side wall 1210 below the intermediate point 1250 to be coated by the first composition. For example, the first and second perimeters 1235, 1240 may have substantially the same size and shape. The discontinuity 1320 may facilitate later separation of the sacrificial layer 1100 and the layer 1315 from the metal-containing protective shell.

At step 430, a metal-containing body 1405 is formed in the first part 1305 of the metal-containing protective shell. The metal-containing body 1405 is formed of a second composition. The second composition may be selected in the same manner as discussed above in connection with selecting the second composition of the metal-containing body 210 formed in step 120 of the method 100. The metal-containing body 1405 is formed in the cavity 1205 by utilizing a selected technique for depositing the second composition as a layer 1410 onto the layer 1315 of the first composition, and into the first part 1305 of the metal-containing protective shell. As examples, the selected depositing technique may include evaporation, sputtering, or electroplating.

At step 435, a second part 1505 of a metal-containing protective shell 1510 is formed on the opening 1310, enclosing the metal-containing body 1405 together with the first part 1305 of the metal-containing protective shell 1510. The second part 1505 of the metal-containing protective shell 1510 is formed of a selected metal-containing composition. The metal-containing composition of the second part 1505 of the metal-containing protective shell 1510 may be selected in the same manner as discussed above in connection with selecting the first composition of the metal-containing protective shell 205 formed in step 120 of the method 100. As an example, the first and second parts 1305, 1505 of the metal-containing protective shell 1510 may have substantially the same composition. The second part 1505 of the metal-containing protective shell 1510 is formed utilizing a selected technique for depositing the selected metal-containing composition onto the layer 1410 and onto the metal-containing body 1405, closing the opening 1310. As examples, the selected depositing technique may include evaporation, sputtering, or electroplating. The selected depositing technique is carried out in a manner such that the second part 1505 of the metal-containing protective shell 1510 is formed simultaneously with deposition of a layer 1515 of the selected metal-containing composition onto the layer 1410 of the second composition, separated by the discontinuity 1320 at the intermediate point 1250. This example of the method 400 may then end at step 440. In another example, the discontinuity 1320 may facilitate separation of the sacrificial layer 1100 and the layers 1315, 1410, 1515 in the same manner as discussed above in connection with FIGS. 4-10.

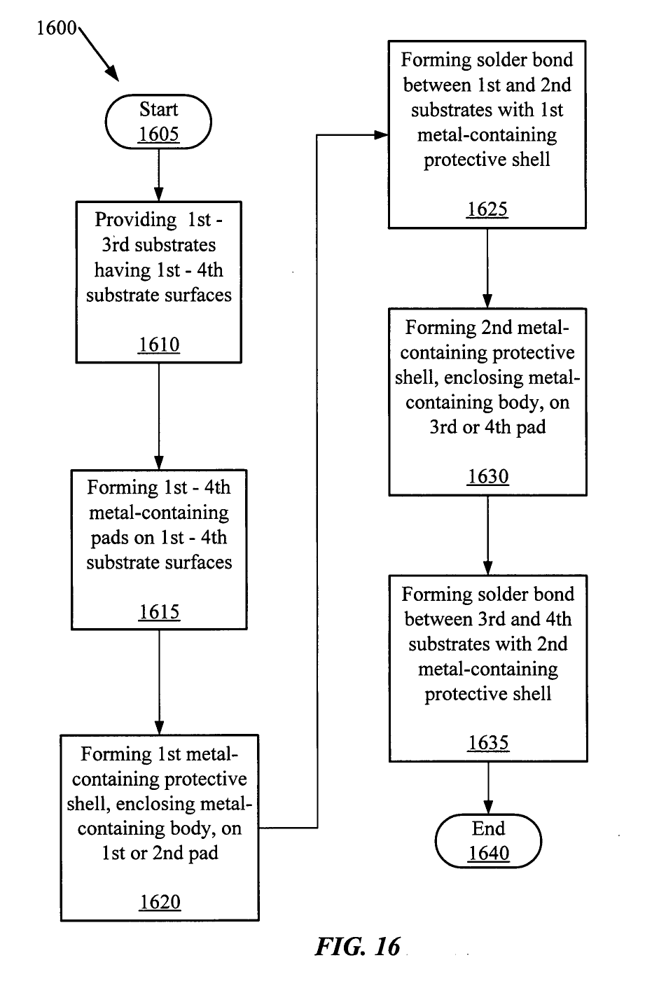

FIG. 16 is a flow chart showing an example of an implementation of an additional method 1600. According to the method 1600, two metal-containing protective shells 205, 565, 1510 each enclosing a metal-containing body 210, 582, 1405, are each formed on a metal-containing pad 215, 515 on a substrate surface 220, 510. The methods 100, 400 discussed above in connection with FIGS. 1-15 may be utilized in forming each of the metal-containing protective shells 205, 565, 1510. The entireties of the above discussions of the methods 100, 400 in connection with FIGS. 1-15 are fully applicable in carrying out the method 1600, and hereby are incorporated in this discussion of the method 1600. The method 1600 starts at step 1605, and then at step 1610 three substrates 225, 505 are provided, including a first substrate having a first substrate surface, a second substrate having second and third substrate surfaces, and a third substrate having a fourth substrate surface. In step 1615, first, second, third and fourth metal-containing pads 215, 515 are formed on the first, second, third and fourth substrate surfaces.

At step 1620, a first metal-containing protective shell 205, 565, 1510 is formed on the first or second metal-containing pad 215, 515. At least a part of the first metal-containing protective shell 205, 565, 1510 has a first composition. The first metal-containing protective shell 205, 565, 1510 encloses a metal-containing body 210, 582, 1405 having a second composition.

In step 1625, first and second substrate surfaces 220, 510 are juxtaposed with the first metal-containing protective shell 205, 565, 1510 aligned between and contacting the first and second metal-containing pads 215, 515. As an example, the contact between the first and second substrate surfaces 220, 510 may also be placed under pressure. The first metal-containing protective shell 205, 565, 1510 is then heated to a first temperature to form a solder-bond between the first and second substrate surfaces 220, 510. As examples, the first temperature may be within a range of between about 160° C. and about 240° C. For example, where the first composition includes gold and the second composition includes indium, the first temperature may be within a range of between about 170° C. and about 180° C.

At step 1630, a second metal-containing protective shell 205, 565, 1510 is formed on the third or fourth metal-containing pad 215, 515. At least a part of the second metal-containing protective shell 205, 565, 1510 has a third composition. The second metal-containing protective shell 205, 565, 1510 encloses a metal-containing body 210, 582, 1405 having a fourth composition.

In step 1635, the third and fourth substrate surfaces 220, 510 are juxtaposed with the second metal-containing protective shell 205, 565, 1510 aligned between and contacting the third and fourth metal-containing pads 215, 515. As an example, the contact between the third and fourth substrate surfaces 220, 510 may also be placed under pressure. The second metal-containing protective shell 205, 565, 1510 is then heated to a second temperature to form a solder-bond between the third and fourth substrate surfaces 220, 510. As examples, the second temperature may be within a range of between about 160° C. and about 240° C. For example, where the first composition includes gold and the second composition includes indium, the second temperature may be within a range of between about 170° C. and about 180° C. The method 1600 may then end at step 1640. As another example, a fourth substrate may be solder-bonded together with the 1^{st}-3^{rd} substrates by forming a metal-containing pad on a surface of the fourth substrate, forming a metal-containing protective shell enclosing a metal-containing body on a metal-containing pad on an exposed surface of one of the substrates, and forming a solder bond in a manner analogous to step 1635 between an exposed surface of one of the 1^{st}-3^{rd} substrates and the fourth substrate. In further examples, a fifth or successive substrate may be solder-bonded to an exposed surface of one of the foregoing substrates by repeating steps of the method 1600 in an analogous manner. In a further example, a plurality of solder-bonds may be formed between the same two substrates.

The first and second temperatures may, for example, be substantially the same. As an example, the first and second temperatures may differ by less than about 5° Celsius. For example, where the first composition of both of the first and second metal-containing protective shells 205, 565, 1510 includes gold, and the second composition of both of the first and second metal-containing bodies 210, 582, 1405 includes indium, both of the first and second temperatures may be within a range of between about 170° C. and about 180° C. Following the formation of a solder bond between the first and second substrates 225, 505 at step 1625, the gold and indium may then form an inter-metallic alloy having a melting point greater than 400° C. In another example, a melting temperature of a solder-bond including an inter-metallic compound may be increased by annealing the solder-bond. Subsequent heating of the second metal-containing protective shell 205, 565, 1510 to a temperature within a range of between about 170° C. and about 180° C. may then be adequate to form a solder bond between the third and fourth substrates 225, 505, while not high enough to disturb the solder bond between the first and second substrates.

As examples, each of the first and third compositions may include one or more elemental metals selected from gold, palladium, platinum, and silver. In further examples, each of the second and fourth compositions may include one or more elemental metals selected from indium, tin, copper, bismuth, zinc and lead.

The methods 100, 400 may be broadly utilized in forming a metal-containing protective shell enclosing a metal-containing body on a metal-containing pad on a substrate surface, suitable for forming a solder-bond between the substrate, and another substrate. Likewise, the method 1600 may be broadly utilized in forming solder-bonds between three or more substrates. While the foregoing description refers in some instances to the methods 100, 400, 1600 as shown in FIGS. 1-16, it is appreciated that the subject matter is not limited to these methods, nor to the methods discussed in the specification. Further, it is understood by those skilled in the art that the methods 100, 400, 1600 may include additional steps and modifications of the indicated steps.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A method, comprising:
providing a substrate having a substrate surface;
forming a metal-containing pad on the substrate surface; and
forming a solder composition including a metal-containing protective shell on the metal-containing pad, at least a part of the metal-containing protective shell having a first composition, the metal-containing protective shell enclosing a metal-containing body having a second composition.

2. The method of claim 1, where the first composition is resistant to air oxidation.

3. The method of claim 1, where the first composition includes one or more elemental metals selected from the group consisting of gold, palladium, platinum, and silver.

4. The method of claim 1, where the second composition is susceptible to air oxidation.

5. The method of claim 1, where the second composition includes one or more elemental metals selected from the group consisting of indium, tin, copper, bismuth, zinc and lead.

6. The method of claim 1, where the second composition includes a low-melting elemental metal capable of forming an inter-metallic alloy with one or more elemental metals selected from the group consisting of gold, palladium, platinum, and silver, and the inter-metallic alloy has a melting point higher than a melting point of the low-melting elemental metal.

7. A method, comprising:
providing a substrate having a substrate surface;
forming a metal-containing pad on the substrate surface;
forming a sacrificial layer on the metal-containing pad, the sacrificial layer including a top surface and a cavity having a side wall, the side wall extending between the metal-containing pad and the top surface, the side wall having a first perimeter at the top surface and a second perimeter proximate to the metal-containing pad and a third perimeter at an intermediate point between the top surface and the metal-containing pad, the third perimeter being larger than the first and second perimeters;
forming a first part of a metal-containing protective shell in the cavity, the first part of the metal-containing protective shell having an opening proximate to the intermediate point, the first part of the metal-containing protective shell having a first composition;
forming in the first part of the metal-containing protective shell, a metal-containing body having a second composition; and
forming a second part of the metal-containing protective shell at the opening, the first and second parts of the metal-containing protective shell enclosing the metal-containing body.

8. The method of claim 7, where the first composition is resistant to air oxidation.

9. The method of claim 7, where the first composition includes one or more elemental metals selected from the group consisting of gold, palladium, platinum, and silver.

10. The method of claim 7, where the second composition is susceptible to air oxidation.

11. The method of claim 7, where the second composition includes one or more elemental metals selected from the group consisting of indium, tin, copper, bismuth, zinc and lead.

12. The method of claim 7, where the second part of the metal-containing protective shell has the first composition.

13. The method of claim 7, where the second composition includes a low-melting elemental metal capable of forming an inter-metallic alloy with one or more elemental metals selected from the group consisting of gold, palladium, platinum, and silver, and the inter-metallic alloy has a melting point higher than a melting point of the low-melting elemental metal.

14. The method of claim 7, where forming the sacrificial layer includes successively forming first, second and third sacrificial sub-layers on the metal-containing pad; and selectively removing the third, second and first sacrificial sub-layers over lateral regions of the substrate surface, the second sacrificial sub-layer being removed over a larger lateral region than the third sacrificial sub-layer.

15. The method of claim 14, including forming the second sacrificial sub-layer as more susceptible than the first and third sacrificial sub-layers to dissolution by a solvent.

16. The method of claim 7, where forming the sacrificial layer includes successively forming first, second and third sacrificial sub-layers on the metal-containing pad; selectively removing the third and second sacrificial sub-layers over a lateral region of the first sacrificial sub-layer; isotropically etching the first sacrificial sub-layer to a partial depth toward the metal-containing pad; and anisotropically etching the first sacrificial sub-layer over the metal-containing pad.

17. The method of claim 7, where the metal-containing body has a volume within a range of between about 100 cubic microns and about 19 million cubic microns.

18. A method, comprising:
providing a first substrate having a first substrate surface, a second substrate having second and third substrate surfaces, and a third substrate having a fourth substrate surface;
forming first, second, third and fourth metal-containing pads respectively on the first, second, third and fourth substrate surfaces;
forming a first metal-containing protective shell on the first or second metal-containing pad, at least a part of the first metal-containing protective shell having a first composition, the first metal-containing protective shell enclosing a metal-containing body having a second composition;
juxtaposing the first and second substrate surfaces with the first metal-containing protective shell aligned between and contacting the first and second metal-containing pads, and heating the first metal-containing protective shell to a first temperature to form a solder-bond between the first and second substrate surfaces;
forming a second metal-containing protective shell on the third or fourth metal-containing pad, at least a part of the second metal-containing protective shell having a third composition, the second metal-containing protective shell enclosing a metal-containing body having a fourth composition; and
juxtaposing the third and fourth substrate surfaces with the second metal-containing protective shell aligned between and contacting the third and fourth metal-containing pads, and heating the second metal-containing protective shell to a second temperature to form a solder-bond between the third and fourth substrate surfaces.

19. The method of claim 18, where each of the first and third compositions includes one or more elemental metals selected from the group consisting of gold, palladium, platinum, and silver, and where each of the second and fourth compositions includes one or more elemental metals selected from the group consisting of indium, tin, copper, bismuth, zinc and lead, and where the first and second temperatures differ by less than about 5° Celsius.

20. The method of claim 18, including:
forming a sacrificial layer on the first or second metal-containing pad, the sacrificial layer including a top surface and a cavity having a side wall, the side wall extending between the metal-containing pad and the top surface, the side wall having a first perimeter at the top surface and a second perimeter proximate to the metal-containing pad and a third perimeter at an intermediate point between the top surface and the metal-containing pad, the third perimeter being larger than the first and second perimeters;
forming a first part of the first metal-containing protective shell in the cavity, the first part of the first metal-containing protective shell having an opening proximate to the intermediate point, the first part of the first metal-containing protective shell having the first composition;
forming in the first part of the first metal-containing protective shell, the metal-containing body having the second composition; and
forming a second part of the first metal-containing protective shell at the opening, the first and second parts of the first metal-containing protective shell enclosing the metal-containing body.
